(19) United States
(12) Patent Application Publication
(10) Pub. No.: US 2014/0060062 A1
(43) Pub. Date: Mar. 6, 2014

(54) METHOD, APPARATUS AND SYSTEM FOR CONTROLLING SWIRL OF EXHAUST IN A GAS TURBINE

(71) Applicants: Thangaraj Subbareddyar, Bangalore (IN); Mahendhra Muthuramalingam, Bangalore (IN); Nachiket Chilhatey, Bangalore (IN)

(72) Inventors: Thangaraj Subbareddyar, Bangalore (IN); Mahendhra Muthuramalingam, Bangalore (IN); Nachiket Chilhatey, Bangalore (IN)

(73) Assignee: General Electric Company, Schenectady, NY (US)

(21) Appl. No.: 13/603,059

(22) Filed: Sep. 4, 2012

(51) Int. Cl. F02C 7/00; F03G 7/06

(52) U.S. Cl. 60/772; 60/527; 60/39.5

(57) ABSTRACT

Change in swirl of gas turbine exhaust gases at off-design conditions is a key driver of exhaust diffuser inefficiency that adversely impact the gas turbine performance. Conventional ways to control swirl such as blowing, suction, and vortex generation are undesirable since they require parasitic power, are complex to design, and dilute the exhaust gas energy. To address such short comings, shape memory devices are incorporated into struts of an exhaust diffuser of a gas turbine. The shape memory devices change shape in accordance with heat, which can be applied through memory device heaters. By controlling the memory device heaters, the heat applied to the shape memory devices can be controlled. The shapes of the struts can be altered through altering the shapes of the memory device in consideration of load conditions to increase the efficiency.

One or more aspects of the present invention relate to method, apparatus and system for controlling swirl of exhaust in a gas turbine. In particular, one or more aspects relate to improving gas turbine part load performance.

### BACKGROUND OF THE INVENTION

A typical gas turbine system includes a compressor, one or more combustors, and a turbine at the rear. The compressor compresses ambient air. The compressed air exits the compressor and flows to the combustors where it mixes with fuel and ignites to generate combustion gases having high temperature and pressure. The high energy gas exits the combustors and flow to the gas turbine where they expand to produce work. An exhaust diffuser downstream of the turbine converts the kinetic energy of the exhaust gas flow exiting the turbine into potential energy in the form of increased static pressure. The exhaust diffuser typically includes struts that support the bearing.

Change in swirl of gas turbine exhaust gases at off-design/part load conditions is a key driver of exhaust diffuser inefficiency that adversely impacts gas turbine performance. Conventional ways to control the swirl include blowing, suction, vortex generation, and so on. Unfortunately, these methods are complex to design, operate, require higher parasitic power and dilute the exhaust energy which can negate any efficiency gains.

It would be desirable to control the swirl, tunable at part loads, with reduced auxiliary power and maintaining the exhaust energy grade.

### BRIEF SUMMARY OF THE INVENTION

An aspect of the present invention relates to a strut of an exhaust diffuser of a gas turbine. The strut can comprise a foil part, one or more shape memory devices attached to the foil part, and one or more memory device heaters. Each shape memory device can be structured to change its shape in accordance with a temperature of that shape memory device. Each memory device heater can be structured to apply heat to at least one shape memory device in accordance with an externally provided shape actuating signal.

Another aspect of the present invention relates to an exhaust diffuser of a gas turbine. The exhaust diffuser can comprise a shroud, a wall surrounding the shroud, and a plurality of struts extending from the shroud to the wall so as to define a plurality of exhaust flow passages. Each flow passage can be bounded by the shroud, the wall and adjacent struts. At least one strut can comprise a foil part, one or more shape memory devices attached to the foil part, and one or more memory device heaters. Each shape memory device can be structured to change its shape in accordance with a temperature of that shape memory device. Each memory device heater can be structured to apply heat to at least one shape memory device in accordance with an externally provided shape actuating signal.

Another aspect of the present invention relates to a gas turbine system. The gas turbine system can comprise a compressor structured to compress oxidant and provide compressed oxidant, a combustor structured to combust a mixture of fuel and the compressed oxidant from the compressor and provide high energy gas, a gas turbine structured convert energy of the high energy gas from the combustor into useful work, and a controller structured to control an operation of the gas turbine system. The gas turbine can include an exhaust diffuser. The exhaust diffuser itself can comprise a shroud, a wall surrounding the shroud, and a plurality of struts extending from the shroud to the wall so as to define a plurality of exhaust flow passages. Each flow passage can be bounded by the shroud, the wall and adjacent struts. At least one strut can comprise a foil part, one or more shape memory devices attached to the foil part, and one or more memory device heaters. Each shape memory device can be structured to change its shape in accordance with a temperature of that shape memory device. Each memory device heater can be structured to apply heat to at least one shape memory device in accordance with a shape actuating signal provided from the controller. The controller can be structured to receive one or more sensor signals from one or more of a compressor sensor, a combustor sensor, a turbine sensor, an ambient sensor and a load sensor. Based on these sensor signals, the controller can provide the shape actuating signals to the to the memory device heaters.

Another aspect of the present invention relates to a method for controlling exhaust gases exiting through an exhaust diffuser of a gas turbine of a gas turbine system such as the gas turbine system described above. The method can comprise a step of receiving, at the controller of the gas turbine system, one or more sensor signals from one or more of a compressor sensor, a combustor sensor, a turbine sensor, an ambient sensor and a load sensor. The method can also comprises providing from the controller one or more shape actuating signals based on the sensor signals.

The invention will now be described in greater detail in connection with the drawings identified below.

### BRIEF DESCRIPTION OF THE DRAWINGS

These and other features of the present invention will be better understood through the following detailed description of example embodiments in conjunction with the accompanying drawings, in which:

FIG. 1 illustrates a front view of an example exhaust diffuser embodiment of a gas turbine according to the present invention;

FIGS. 2 and 3 illustrate top and side views of an example strut embodiment of the present invention;

FIGS. 4 and 5 illustrate example changes in the exhaust flow passage as due to changes in shape memory devices;

FIG. 6 illustrates an architecture of an example gas turbine system embodiment according to the present invention; and

FIG. 7 illustrates a flow chart of an example method to control exhaust gases according to the present invention.

### DETAILED DESCRIPTION OF THE INVENTION

Novel method, system, and apparatus for controlling swirl of exhaust gas in a gas turbine are described. In one aspect, the described method, system, and apparatus utilize memory materials to control the flow area of the exhaust gas, the swirl angle of the exhaust gas, or both based on the load on the gas turbine.

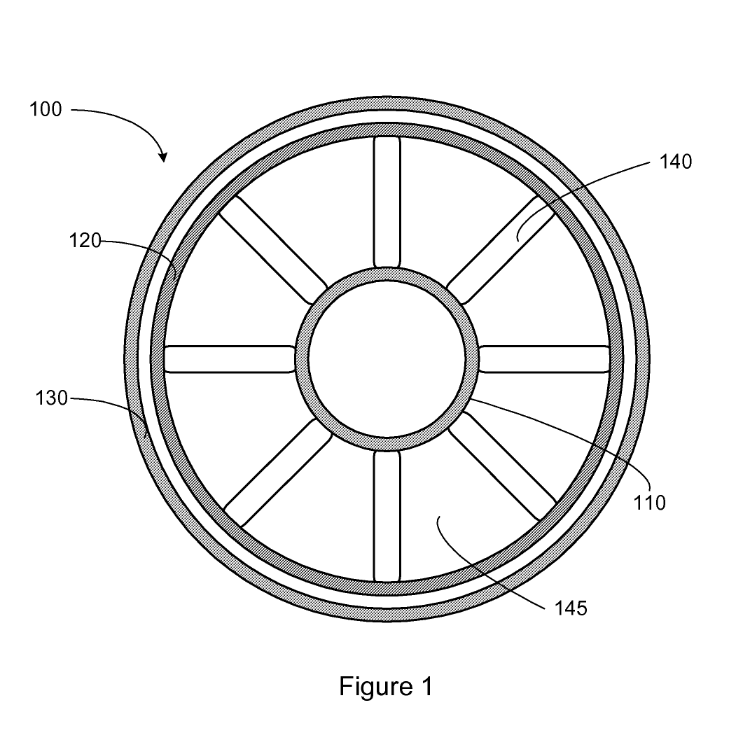

FIG. 1 illustrates a front view of an example exhaust diffuser embodiment of a gas turbine according to the present invention. As seen the example exhaust diffuser 100 can include a shroud 110 and a wall 120 that surrounds the shroud 110. The exhaust diffuser 100 may be double walled. In this instance, the exhaust diffuser 100 may also comprise an outer wall 130 that surrounds the wall 120, which may also be referred to as the inner wall 120. The exhaust diffuser 100 can include a plurality of struts 140. Each strut 140 can extend from the shroud 110 to the wall 120. A plurality of exhaust flow passages 145 can be defined. Each flow passage 145 can be bounded by the shroud 110, the wall 120 and adjacent struts 140.

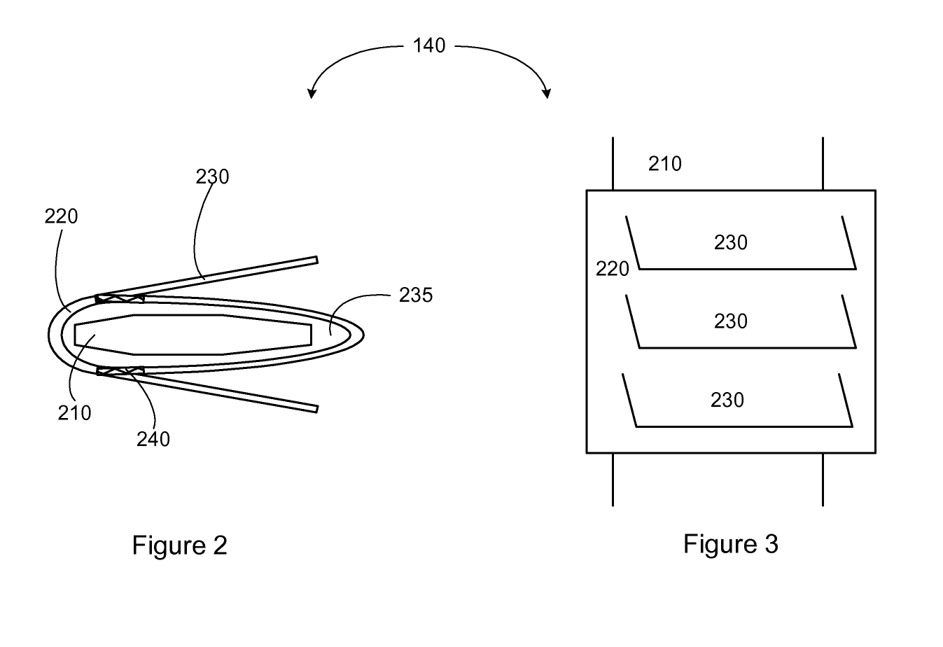

FIG. 2 illustrates a top view and FIG. 3 illustrates a side view of an example strut 140. As seen in these figures, the strut 140 can include a support part 210 and a foil part 220 that surrounds the support part 210. A strut cavity 235 can be formed in between the support part 210 and the foil part 220. In one aspect, the strut cavity 235 can be used to carry cooling fluid so as to keep the temperature of the strut 140 within a predetermined range.

The strut 140 can also include one or more shape memory devices 230 attached to the foil part 220. Preferably all, but at least one shape memory devices 230 can be structured to change its shape in accordance with a temperature of that shape memory device 230. The shape memory device 230 may be a memory metal such as a nickel-titanium alloy. Memory metals are also referred to as shape memory alloy (SMA), shape memory metal (SMM), smart metal, memory alloy, smart alloy, and so on. There are known uses for smart materials. Semmere et al. (U.S. Pat. No. 7,462,976 B2) and Care et al. (U.S. Pat. No. 6,485,255 B1), both incorporated by reference herein in their entirety, disclose examples of such known uses. When heat is applied to the memory metal, its shape can change.

Shape characteristics—e.g., first shape at first temperature, second shape at second temperature, and so on—of the memory metal, or more generally, of the shape memory device 230 may be designed into the device 230. When there are multiple shape memory devices 230, they all need not be exactly alike. That is, at least two shape memory devices 230 can differ in their shape characteristics.

As seen in FIG. 2, the strut 140 can include one or more memory device heaters 240. Each memory device heater 240 can be provided with a shape actuating signals from an external source, such as from a controller which is described in further detail below. Based on the provided shape actuating signal, each memory device heater 240 can apply heat to at least one shape memory device 230 so as to affect the shape of that shape memory device 230. The amount of heat applied can vary in accordance with the shape actuating signal provided to that memory device heater 240. One example of the memory device heater 240 is an electrically powered heater, such as a resistor or a coil.

In one aspect, a memory device heater 240 can be attached to a shape memory device 230. This provides a direct way to apply heat to the attached shape memory device 230. In another aspect, a memory device heater 240 can be attached to the foil part 220 and in close proximity to a shape memory device 230 such that the heat from the memory device heater 240 is applied to that shape memory device 230. That is, the memory device heater 240 and the shape memory device 230 can be considered to be in thermal connection with each other. In yet another aspect, the memory device heater 240 may be a microwave device structured to apply microwave energy to a shape memory device 230.

When there are multiple memory device heaters 240, they all need not be exactly alike. For example, one memory device heater 240 can be a resistor and another may be a coil. As another example, one may be capable of applying relatively high heat as opposed to another. Also, the strut 140 may be structured such that a common shape actuating signal is provided to all memory device heaters 240 of the strut 140. Alternatively, the strut 140 may be structured such that at least one memory device heater 240 receives its corresponding shape actuating signal independent of the shape actuating signal received by another memory device heater 240.

There can be any number of shape memory devices 230 and any number of memory device heaters 240, and the two need not necessarily be equal. In one aspect, one memory device heater 240 can be structured to apply heat to multiple shape memory devices 230. In another aspect, one shape memory device 230 may be heated by multiple memory device heaters 240.

When the numbers of the shape memory devices 230 and of the memory device heaters 240 are equal, there can be one-to-one correspondence. That is, the strut 140 can be structured such that each memory device heater 240 applies heat to only one shape memory device 230. Alternatively, even when the numbers are equal, a group of memory device heaters 240, the group comprising more than one memory device heater 240, may commonly apply heat to a group of shape memory devices 230, again the group comprising more than one shape memory devices 230.

Use of memory device heaters 240 is one way to apply heat to the shape memory devices 230. In another way, the cooling fluid flowing within the strut cavity 235 can also be used. That is, one or more shape memory devices 230 can be thermally connected with the cooling fluid via the foil part 220. By controlling the temperature of the cooling fluid, heat applied to the shape memory devices 230 can be controlled. The cooling fluid and the memory device heaters 240 can be used exclusive of each other or can be used in combination.

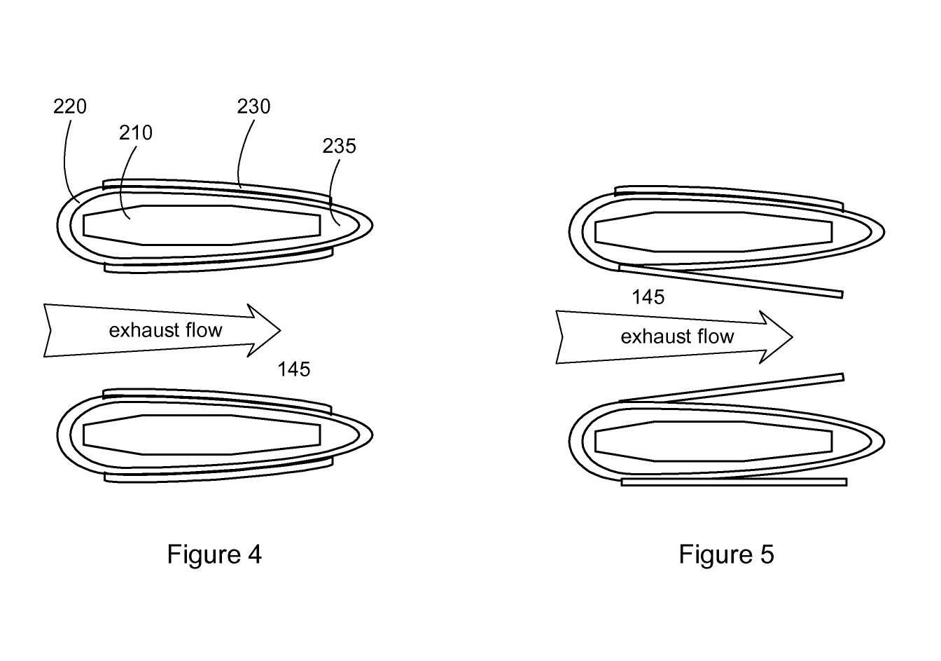

FIGS. 4 and 5 illustrate example changes in the exhaust flow passage 145 as due to changes in shape memory devices 230. Under normal operating conditions, shape actuating signals may be provided to the memory device heaters 240 (not shown in these figures) so as to control the shapes of the shape memory devices 230 to maximize the area of the exhaust flow passage 145 as illustrated in FIG. 4. Often, the foil part 220 is aerodynamically contoured. Thus, the shape memory devices 230 may be structured substantially conform to the contour of the outer strut 220 when maximum exhaust flow area is desired. Of course, this is not a strict requirement.

Under part load conditions, the rate of the exhaust flow is reduced. Thus, it is also desirable to correspondingly reduce the area of the exhaust flow passage 145 as illustrated in FIG. 5. This can be accomplished by providing the appropriate shape actuating signal or signals to the one or more memory device heaters 240.

Note that the shapes of the shape memory devices 230 need not be the same under all operating conditions. As indicated above, one shape memory device 230 can differ in its shape characteristics from another shape memory device 230. But even if two shape memory devices 230 have identical shape characteristics, the applied heat can be different for the two devices. For example, the strut 140 can be structured such that the shape actuating signal received by at least one memory device heater 240 is independent of the actuating signal received by at least one other memory device heater 240.

The shape memory devices 230 can be controlled so as to affect not only the area of the exhaust flow passage 145, but also affect the swirl angle of the exhaust gas flow. More generally, by providing appropriate shape actuating signal or signals to the one or more memory device heaters 240, one or both of the area of the exhaust flow passage 145 and the swirl angle of the exhaust gas flowing through the exhaust flow passage 145 can be controlled.

Recall that in addition to the adjacent struts 140, each exhaust flow passage 145 can also be bounded by the shroud 110 and the wall 120. Thus, while not particularly illustrated in the figures, one or more shape memory devices 230 can be attached to the shroud 110 or to the wall 120 along with one or more memory device heaters 240 structured to apply heat to the shroud 110 or the wall 120 attached shaped memory devices 230 in accordance with the received shape actuating signals. Through providing appropriate shape actuating signals to these memory device heaters 240, the area of the exhaust flow passage 145 and/or the swirl angle of the exhaust gas flowing through the exhaust flow passage 145 can also be controlled.

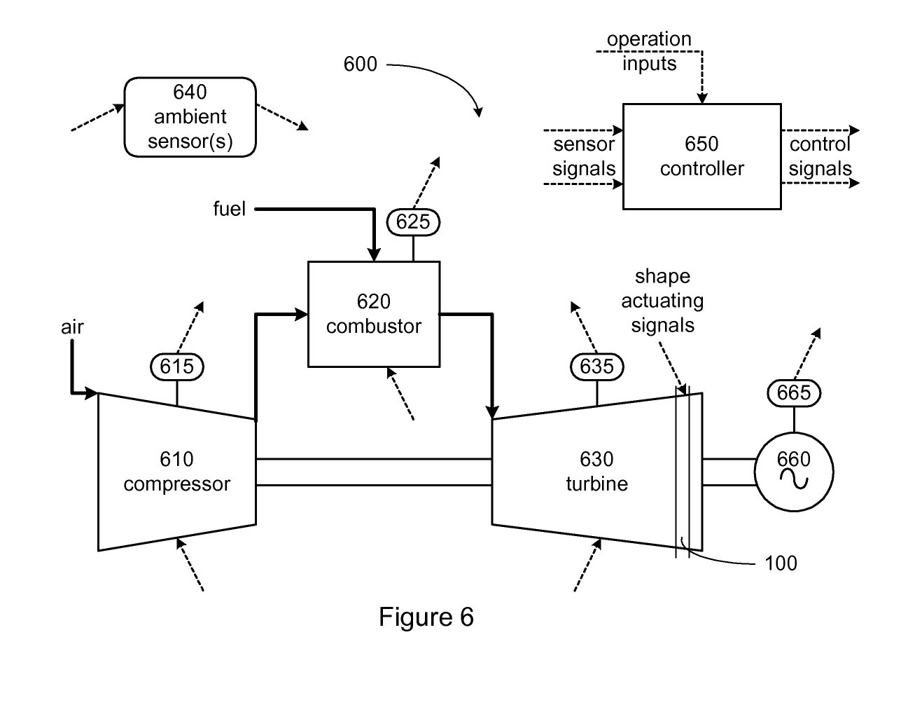

FIG. 6 illustrates an architecture of an example gas turbine system 600. As seen, the system 600 may include a compressor 610, a combustor 620 fluidly connected to the compressor 610, and a gas turbine 630 fluidly connected to the combustor 620. The compressor 610 can be structured to compress oxidant, e.g., air, and provide the compressed oxidant to the combustor 620. The combustor 620 can be structured to combust a mixture of fuel and the compressed oxidant and provide high energy gas to the gas turbine 630, which can in turn be structured convert energy of the high energy gas from into useful work to drive a load 660. In FIG. 6, the load 660 is a generator, and the useful work is in the form of mechanical energy used to drive the generator to generate electricity. While not shown, the useful work can come in a form of a thrust which can be used to propel an airplane.

The system 600 can include any one or more of a compressor sensor 615, a combustor sensor 625, a turbine sensor 635 and a load sensor 665, each structured to monitor its respective system component. For example, the compressor sensor may detect or otherwise determine any one or more of an intake oxidant temperature, oxygen content of the compressed oxidant, pressure of the compressed oxidant, compressor discharge temperature, etc. The combustor sensor 625 may detect or otherwise determine any one or more of a combustion temperature and acoustical dynamics. The turbine sensor 635 may detect or otherwise determine any one or more of an exhaust temperature and pressure, flow rate of the energized gas through various stages (e.g., high pressure, intermediate pressure, low pressure), etc. The load sensor 665 may detect or otherwise determine the load on the gas turbine 630. The system 600 can also include one or more ambient sensors 640 that are not necessarily specific to any of the system component. For example, an ambient sensor 640 may detect or determine an ambient temperature.

The system 600 can also include a controller 650 structured to control an operation of the gas turbine system 600. As seen, the controller 650 can receive as inputs the sensor signals from any one or more of the sensors 615, 625, 635, 640, 665. The controller 650 can also receive operation inputs such as instructions for start up, partial load operation, full load operation, shut down, and so on. Based on the inputs, the controller 650 can output control signals to any one or more of the system components 610, 620, 630.

In FIG. 6, the sensor signals from the sensors 615, 625, 635, 640, 665 to the controller 650 and the control signals from the controller 650 to the system components 610, 620, 630. To minimize clutter, the connections of the sensor and control signals between the controller 650 and the system units 610, 620, 630 are not explicitly shown.

Among the control signals, the controller 650 can provide one or more shape actuating signals to the external diffuser 100 located towards the exhaust end of the gas turbine 630. In particular, the controller 650 can provide the shape actuating signals to the one or more memory device heaters 240. These shape actuating signals can be based on the load signal indicative of the load on the gas turbine 630. The load signal can be provided by the load sensor 660. The shape actuating signals can also be based on an ambient temperature signal from one of the ambient sensors 640 that detects or determines an ambient temperature. Just for explanatory purposes and not as a limitation, a range of ambient temperature may range between −20° F. and 120° F. Generally, a drop in ambient temperature results in a reduction of the exhaust temperature.

Other sensor signals that may be taken into account by the controller 650 in providing the shape actuating signals include temperature of the compressor discharge (e.g., from the compressor sensor 615) and the gas turbine exhaust temperature (e.g., from the turbine sensor 635). Of course, these are not exhaustive. It suffices to indicate that many of the sensor inputs that are taken into account to actuate swirl control may also serve as inputs taken into account to provide shape actuating signals.

Recall from above discussion that between any two memory device heaters 240, they need not receive the same shape actuating signal even under identical circumstances. For example, assume that at least one strut 140 comprises multiple memory device heaters 240 including first and second memory device heaters 240 respectively structured to apply heat to first and second shape memory devices 230. The controller 650 can provide a first shape actuating signal to the first shape memory device 230 and independently provide a second shape actuating signal to the second shape memory device 230.

As another example, assume that the exhaust diffuser 100 includes multiple struts 140 including first and second struts 140. The controller 650 can provide a first shape actuating signal to one or more memory device heaters 240 of the first strut 140 and independently provide a second shape actuating signal to one or more memory device heaters 240 of the second strut 140. The first and second actuating signals in regards the first and second struts 140 discussed in this paragraph are not necessarily the same as the first and second actuating signals in regards the first and second memory device heaters 240 discussed in the previous paragraph.

Flexibility to provide independent shape actuating signals to a particular strut 140 can allow the controller 650 to finely control the shapes of the shape memory units 230 of that particular strut 140. Flexibility to provide independent shape actuating signals among the struts 140 can allow the controller 650 to finely control the shapes of the shape memory units 230 across the plurality of struts 140. Of course, both flexibility within and among the struts are possible.

In another aspect, the control signals can include signals to control one or both of a temperature and a flow rate of the cooling fluid flowing within the strut cavity 235 of one or more struts 140. The shape change actuating signals and the cooling fluid control signals can be exclusive of each other or in conjunction with each other.

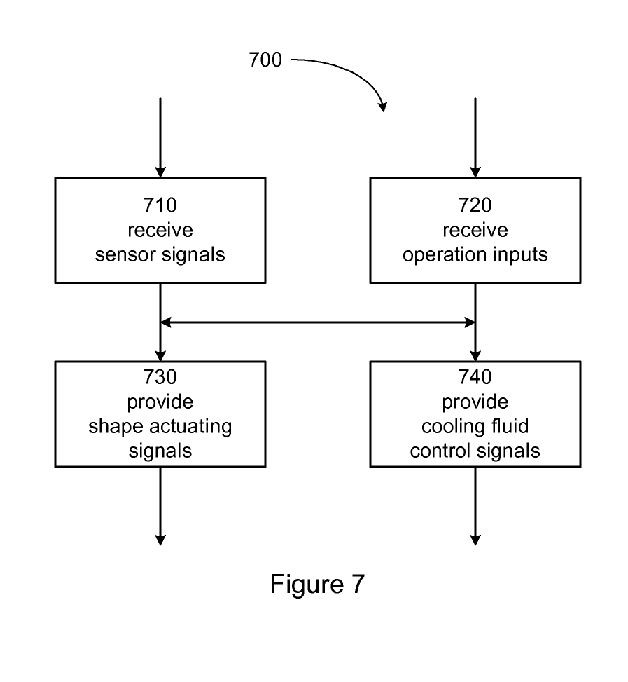

FIG. 7 illustrates a flow chart of an example method to control exhaust gases exiting through an exhaust diffuser of a gas turbine of a gas turbine system. For purposes of explanation, the gas turbine system 600 of FIG. 6 is assumed. The method 700 in FIG. 7 can be performed by the controller 650.

In step 710, the controller 650 can receive sensor signals from any one or more of the sensors 615, 625, 635, 640 and 665. A load signal indicative of the load on the gas turbine 630, e.g., from the load sensor 665, may be included among the received sensor signals. In step 720, the controller 650 may also receive one or more operation inputs. Based at least on the received load signal, the controller 650 in step 730 may provide one or more shape actuating signals to one or more memory device heaters 240. Alternative to or in conjunction with step 730, the controller 650 can provide one or more cooling fluid control signals to the gas turbine 630 based on the sensor and/or operation input signals.

In step 710, the received sensor signals may also include ambient temperature signal from the ambient sensor 640. Then in step 730, the ambient temperature signal may also be taken into account when the controller 650 provides the shape actuating signals. In step 730, shaping signals can be independently provided to multiple memory device heaters 240 within any particular strut, independently provided to multiple struts 140, or both.

Several advantages can be realized by one or more aspects of the disclosed subject matter. A non-exhaustive list of advantages include:
Improved efficiency;
Improved part-load operation; and
Reduced auxiliary power to control exhaust swirl.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A strut of an exhaust diffuser of a gas turbine, the strut comprising:
a foil part;
one or more shape memory devices attached to the foil part, each shape memory device being structured to change its shape in accordance with a temperature of that shape memory device; and
one or more memory device heaters, each memory device heater being structured to apply heat to at least one shape memory device in accordance with a shape actuating signal provided to that memory device heater, the shape actuating signal being provided from an external source.

2. The strut according to claim 1, wherein at least one memory device heater is an electrically powered heater.

3. The strut according to claim 2, wherein the electrically powered heater is attached to at least one shape memory device.

4. The strut according to claim 2, wherein the electrically powered heater is attached to the foil part and in physical proximity to at least one shape memory device so as to be thermally connected to that shape memory device.

5. The strut according to claim 1, further comprising a support part such that the foil part surrounds the support part so as to define a strut cavity in between the support part and the foil part,
wherein at least one shape memory device is in thermal connection with a cooling fluid flowing within the strut cavity via the foil part.

6. The strut according to claim 1,
wherein the strut comprises a plurality of shape memory devices including first and second shape memory devices, and
wherein the first shaped memory device is structured to change its shape differently from the second shape memory device.

7. An exhaust diffuser of a gas turbine, the exhaust diffuser comprising:
a shroud;
a wall surrounding the shroud;
a plurality of struts extending from the shroud to the wall so as to define a plurality of exhaust flow passages, each exhaust flow passage being bounded by the shroud, the wall and adjacent struts,
wherein at least one strut comprises:
a foil part;
one or more shape memory devices attached to the foil part, each shape memory device being structured to change its shape in accordance with a temperature of that shape memory device; and
one or more memory device heaters, each memory device heater being structured to apply heat to at least one shape memory device in accordance with a shape actuating signal provided to that memory device heater, the shape actuating signal being provided from an external source.

8. The exhaust diffuser according to claim 7, wherein one or more shape memory devices are structured to change their shapes in accordance with the shape actuating signal so as to alter one or both of an area of the exhaust flow passage and a swirl angle of an exhaust gas flowing through the exhaust flow passage.

9. The exhaust diffuser according to claim 7,
wherein the exhaust diffuser comprises a plurality of shape memory devices including first and second shape memory devices, and
wherein the first shaped memory device is structured to change its shape differently from the second shape memory device.

10. The exhaust diffuser according to claim 9, wherein the first and second shaped memory devices are of one strut.

11. The exhaust diffuser according to claim 9,
wherein the plurality of struts include first and second struts, and
wherein the first shaped memory device is of the first strut and the second shaped memory device is of the second strut.

12. The exhaust diffuser according to claim 7,
wherein the strut further comprises a support part such that the foil part surrounds the support part so as to define a strut cavity in between the support part and the foil part,
wherein at least one shape memory device is in thermal connection with a cooling fluid flowing within the strut cavity via the foil part.

13. A gas turbine system, comprising:
a compressor structured to compress oxidant and provide compressed oxidant;
a combustor structured to combust a mixture of fuel and the compressed oxidant from the compressor and provide high energy gas;
a gas turbine structured to convert energy of the high energy gas from the combustor into mechanical energy; and
and a controller structured to control an operation of the gas turbine system,
wherein the gas turbine includes an exhaust diffuser, the exhaust diffuser comprising:
a shroud;
a wall surrounding the shroud; and
a plurality of struts extending from the shroud to the wall so as to define a plurality of exhaust flow passages, each exhaust flow passage being bounded by the shroud, the wall and adjacent struts,
wherein at least one strut comprises:
a foil part;
one or more shape memory devices attached to the foil part, each shape memory device being structured to change its shape in accordance with a temperature of that shape memory device; and
one or more memory device heaters, each memory device heater being structured to apply heat to at least one shape memory device in accordance with a shape actuating signal provided to that memory device heater, the shape actuating signal being provided from the controller, and
wherein the controller is structured to:
receive one or more sensor signals from one or more of a compressor sensor, a combustor sensor, a turbine sensor, an ambient sensor and a load sensor, and
provide the shape actuating signals to the to the memory device heaters based on the sensor signals.

14. The gas turbine system according to claim 13,
wherein the exhaust diffuser comprises a plurality of memory device heaters including first and second memory device heaters, and
wherein the controller is structured to provide a first shape actuating signal to the first memory device heater and a second shape actuating signal to the second memory device heater, the first and second shape actuating signals being independent of each other.

15. The gas turbine system according to claim 14, wherein the first and second memory device heaters are of one strut.

16. The gas turbine system according to claim 14,
wherein the plurality of struts include first and second struts, and
wherein the first memory device heaters is of the first strut and the second memory device heaters is of the second strut.

17. The gas turbine system according to claim 13,
wherein the strut further comprises a support part such that the foil part surrounds the support part so as to define a strut cavity in between the support part and the foil part,
wherein at least one shape memory device is in thermal connection with a cooling fluid flowing within the strut cavity via the foil part, and
wherein the controller is structured to provide one or more cooling fluid control signals to control one or both of a temperature and a flow rate of the cooling fluid flowing within the strut cavity.

18. A method for controlling exhaust gases exiting through an exhaust diffuser of a gas turbine of a gas turbine system, the method comprising:
receiving, at a controller of the gas turbine system, one or more sensor signals from one or more of a compressor sensor, a combustor sensor, a turbine sensor, an ambient sensor and a load sensor; and
providing, from the controller, one or more shape actuating signals based on the sensor signals,
wherein the exhaust diffuser comprises:
a shroud;
a wall surrounding the shroud;
a plurality of struts extending from the shroud to the wall so as to define a plurality of exhaust flow passages, each exhaust flow passage being bounded by the shroud, the wall and adjacent struts,
wherein at least one strut comprises:
a foil part;
one or more shape memory devices attached to the foil part, each shape memory device being structured to change its shape in accordance with a temperature of that shape memory device; and
one or more memory device heaters, each memory device heater being structured to apply heat to at least one shape memory device in accordance with a shape actuating signal provided to that memory device heater, the shape actuating signal being provided from the controller, and
wherein in the step of providing the shape actuating signals, the shape actuating signals are provided to the memory device heaters.

19. The method according to claim 18,
wherein the exhaust diffuser comprises a plurality of memory device heaters including first and second memory device heaters, and
wherein in the step of providing the shape actuating signals, a first shape actuating signal is provided to the first memory device heater and a second shape actuating signal is provided to the second memory device heater, the first and second shape actuating signals being independent of each other.

20. The method according to claim 19, wherein the first and second memory device heaters are of one strut.

21. The method according to claim 19,
wherein the plurality of struts include first and second struts, and
wherein the first memory device heaters is of the first strut and the second memory device heaters is of the second strut.

22. The gas method according to claim 18,
wherein the strut further comprises a support part such that the foil part surrounds the support part so as to define a strut cavity in between the support part and the foil part,
wherein at least one shape memory device is in thermal connection with a cooling fluid flowing within the strut cavity via the foil part, and
wherein the method further comprises providing one or more cooling fluid control signals to control one or both of a temperature and a flow rate of the cooling fluid flowing within the strut cavity.

23. The exhaust diffuser according to claim 7, further comprising:
at least one shape memory device attached to the shroud or to the wall; and
at least one memory device heater structured to apply heat to the shaped memory device attached to the shroud or to the wall in accordance with the shape actuating signal.
